(19) United States
(12) Patent Application Publication
(10) Pub. No.: US 2005/0216695 A1
(43) Pub. Date: Sep. 29, 2005

(54) Memory extension for a data processor to provide both common and separate physical memory areas for virtual memory spaces

(76) Inventor: Jean-Pierre Bono, Westboro, MA (US)

Correspondence Address: RICHARD AUCHTERLONIE;NOVAK DRUCE & QUIGG, LLP, 1000 LOUISIANA, SUITE 5320, HOUSTON, TX, 77002, US

(21) Appl. No.: 10/811,045

(22) Filed: Mar. 26, 2004

(51) Int. Cl. G06F 12/08

(52) U.S. Cl. 711/203; 711/209; 711/207

(57) ABSTRACT

A physical address extension feature maps multiple virtual memory spaces to an extended physical memory. Performance is enhanced by mapping chunks of both common and separate physical memory to each of the virtual memory spaces to provide efficient communication of parameters to and results from well-defined or well-contained software modules assigned to the chunks of separate physical memory. For example, the common physical memory stores stack allocation, per-processor data for communication between the virtual address spaces, BIOS, and device drivers. A first virtual memory space is directly mapped to a bottom region of physical memory containing buffer cache and page tables. In a file server, for example, one of the virtual memory spaces contains an inode cache, another contains a domain name lookup cache, and still another contains a block map for snapshot copies.

### FIELD OF THE INVENTION

The present invention relates generally to virtual memory for a data processor, and more particularly, to extension of physical memory beyond a maximum size for virtual memory spaces.

### BACKGROUND OF THE INVENTION

Virtual memory is a term applied to memory systems that allow programs to address more memory than is physically available. Disk storage provides the increased memory by storing data that is not currently being accessed. When data in the disk storage is referenced, the operating system moves data resident in memory to the disk storage, and moves the referenced data from the disk storage into memory. This moving of data between memory and disk storage is called demand paging.

One or more translation tables are typically used for translating the virtual address to a corresponding physical address. For example, the virtual address may be subdivided into a segment number that indexes a segment table, a page number that indexes a page table selected by the indexed entry in the segment table, and a byte offset. In this case, the indexed entry in the page table provides a physical page number, and the physical address is the concatenation of the physical page number and the byte offset. To reduce the time for translating virtual addresses to physical addresses, the most recently used virtual-to-physical address translations can be cached in a high-speed associative memory called a translation buffer. See Henry M. Levy and Richard H. Eckhouse, Jr., Computer Programming and Architecture, The VAX-11, Digital Equipment Corporation, 1980. pp. 250-253, 358-360.

Recently memory has become so inexpensive that it is often desirable for a processor to access more memory than can be addressed in a given virtual address space. For example, the virtual memory address in many microprocessors is limited to 32 bits, so that the virtual address space has a size of four gigabytes. One technique for permitting a 32-bit virtual address to access more than four gigabytes of physical memory is the physical address extension (PAE) feature introduced in the Intel Pentium Pro processor and included in other Intel P6 processors. The PAE feature provides generic access to a 36-bit physical address space by expanding page-directory and page-table entries to an 8-byte (64 bit) format, and adding a page-directory-pointer table. This allows the extension of the base addresses of the page table and page frames from 20 bits to 24 bits. This increase of four bits extends the physical address from 32 bits to 36 bits.

### SUMMARY OF THE INVENTION

It has been found that the three levels of indirection in the address translation of a physical address extension (PAE) feature of a processor may cause a loss of performance unless there is an appropriate assignment of virtual memory spaces to well-defined or well-contained software modules executed by the processor. In addition, mapping chunks of both common and separate physical address to each of the virtual memory spaces enhances performance by providing efficient communication of parameters to and results from the well-defined or well-contained software modules.

In accordance with a first aspect, the invention provides a digital computer including at least one processor producing virtual addresses over a range of virtual addresses, a translation buffer coupled to the processor for translating the virtual addresses to physical addresses, and a random access memory coupled to the translation buffer for addressing by the physical addresses and coupled to the processor for supplying data to the processor. The random access memory contains physical memory having a range of physical addresses that is greater than the range of virtual addresses. The digital computer is programmed with a plurality of virtual-to-physical address mappings to define a plurality of virtual memory spaces. Each of the plurality of virtual memory spaces includes common physical memory that is included in the other of the virtual memory spaces, and at least one of the virtual memory spaces includes a chunk of physical memory that is not included in any other of the plurality of virtual memory spaces. The chunk of physical memory that is not included in any other of the plurality of virtual memory spaces is assigned for use by a software module, and the digital computer is programmed for using the common physical memory for communication of parameters to and results from the software module.

In accordance with another aspect, the invention provides a digital computer including at least one processor producing virtual addresses over a range of virtual addresses, a translation buffer coupled to the processor for translating the virtual addresses to physical addresses, and a random access memory coupled to the translation buffer for addressing by the physical addresses and coupled to the processor for supplying data to the processor. The random access memory contains physical memory having a range of physical addresses that is greater than the range of virtual addresses. The digital computer is programmed with a plurality of virtual-to-physical address mappings to define a plurality of virtual memory spaces. Each of the plurality of virtual memory spaces includes common physical memory that is included in the other of the virtual memory spaces. Each of the plurality of virtual memory spaces includes at least one respective separate chunk of physical memory that is not included in any other of the virtual memory spaces. Each of the respective separate chunks of physical memory is assigned for use by a respective software module. The digital computer is programmed for using the common physical memory for communication of parameters to and results from the software module. The plurality of virtual memory spaces includes at least a first virtual memory space that is directly mapped to a bottom region of the physical memory address space, a second virtual memory space, and a third virtual memory space.

In accordance with still another aspect, the digital computer includes at least one processor producing virtual addresses over a range of virtual addresses, a translation buffer coupled to the processor for translating the virtual addresses to physical addresses, and a random access memory coupled to the translation buffer for addressing by the physical addresses and coupled to the processor for supplying data to the processor. The random access memory contains physical memory having a range of physical addresses that is greater than the range of virtual addresses. The digital computer is programmed with a plurality of virtual-to-physical address mappings to define a plurality of virtual memory spaces. Each of the plurality of virtual memory spaces includes at least one common chunk of physical memory that is included in the other of the virtual memory spaces, and each of the plurality of virtual memory spaces includes at least one respective separate chunk of physical memory that is not included in any other of the virtual memory spaces. Each of the respective separate chunks of physical memory is assigned for use by a respective software module. The digital computer is programmed for using the common chunk of physical memory for communication of parameters to and results from the software module. The plurality of virtual memory spaces include at least a first virtual memory space that is directly mapped to a bottom region of the physical memory address space, a second virtual memory space, and a third virtual memory space. The common chunk of physical memory is at the bottom of the physical address space and includes memory allocated to at least one processor stack. The respective software module assigned to the separate chunk of physical memory in the first virtual address space accesses a buffer cache. Each of the virtual memory spaces includes a chunk of physical memory allocated to BIOS and device drivers, and this chunk of physical memory allocated to BIOS and device drivers is included in each of the plurality of virtual memory spaces and is mapped to a top region of each of the plurality of virtual memory spaces.

In accordance with a final aspect, the invention provides a method of operating a digital computer for executing a first software module and a second software module. The first software module accesses a first virtual memory space and the second software module accesses a second virtual memory space. Each of the first and second virtual memory spaces contains common physical memory. The first virtual memory space includes a first separate chunk of physical memory that is not included in the second virtual memory space and that is accessed by the first software module. The second virtual memory space includes a second separate chunk of physical memory that is not included in the first virtual memory space and that is accessed by the second software module. The method includes transferring execution between the first software module and the second software module by executing the first software module to place at least one parameter in the common physical memory, switching virtual-to-physical address translation from the first virtual memory space to the second virtual memory space, executing the second software module to produce a result from the parameter obtained from the common physical memory, the result being placed in the common physical memory, switching virtual-to-physical address translation from the second virtual memory space to the first virtual memory space, and executing the first software module to obtain the result from the common physical memory.

### BRIEF DESCRIPTION OF THE DRAWINGS

Additional features and advantages of the invention will be described below with reference to the drawings, in which:

FIG. 1 is a block diagram of a data network including clients that share a network file server;

FIG. 2 shows details of a data mover in the data network of FIG. 1;

FIG. 3 is a block diagram of a microprocessor chip in connection with random access memory as used in the data mover of FIG. 2;

FIG. 4 is a flow diagram for virtual-to-physical address translation in the microprocessor chip of FIG. 3;

FIG. 5 shows the mapping of multiple virtual address spaces into physical memory for the data mover of FIG. 2;

FIG. 6 shows a first one of the virtual address spaces in greater detail;

FIG. 7 shows a method of operating the data mover of FIG. 2 for switching between the first one of the virtual address spaces and a second one of the virtual address spaces in order to access a domain name lookup cache (DNLC);

FIG. 8 shows a block map for a snapshot copy;

FIG. 9 shows a snapshot copy facility;

FIG. 10 is a flowchart of a procedure for writing a specified block to a production file system in the snapshot copy facility of FIG. 9; and

FIG. 11 is a flowchart of a procedure for reading a specified block from a specified snapshot version in the snapshot copy facility of FIG. 9.

While the invention is susceptible to various modifications and alternative forms, a specific embodiment thereof has been shown in the drawings and will be described in detail. It should be understood, however, that it is not intended to limit the invention to the particular form shown, but on the contrary, the intention is to cover all modifications, equivalents, and alternatives falling within the scope of the invention as defined by the appended claims.

### DETAILED DESCRIPTION OF THE PREFERRED EMBODIMENT

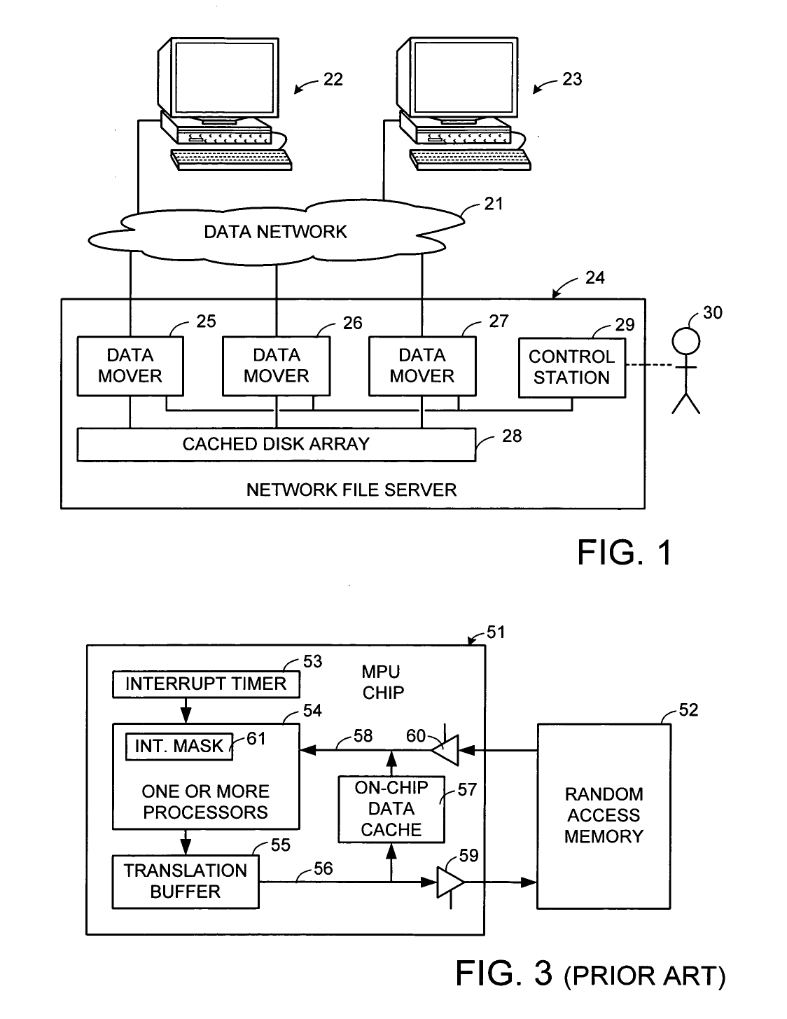

With reference to FIG. 1, there is shown a data processing system incorporating the present invention. The data processing system includes a data network 21 interconnecting a number of clients 22, 23 and servers such as a network file server 24. The data network 21 may include any one or more of network connection technologies, such as Ethernet or Fibre Channel, and communication protocols, such as TCP/IP or UDP. The clients 22, 23, for example, are workstations such as personal computers. Various aspects of the network file server 24 are further described in Vahalia et al., U.S. Pat. No. 5,893,140 issued Apr. 6, 1999, incorporated herein by reference, and Xu et al., U.S. Pat. No. 6,324,581, issued Nov. 27, 2002, incorporated herein by reference. Such a network file server is manufactured and sold by EMC Corporation, 176 South Street, Hopkinton, Mass. 01748.

The network file server 24 includes a cached disk array 28 and a number of data mover computers 25, 26, 27. The network file server 24 is managed as a dedicated network appliance, integrated with popular network operating systems in a way, which, other than its superior performance, is transparent to the end user. The clustering of the data movers 25, 26, 27 as a front end to the cache disk array 28 provides parallelism and scalability. Each of the data movers 25, 26, 27 is a high-end commodity computer, providing the highest performance appropriate for a data mover at the lowest cost. The network file server 27 also has a control station 35 enabling a system administrator 30 to configure and control the file server.

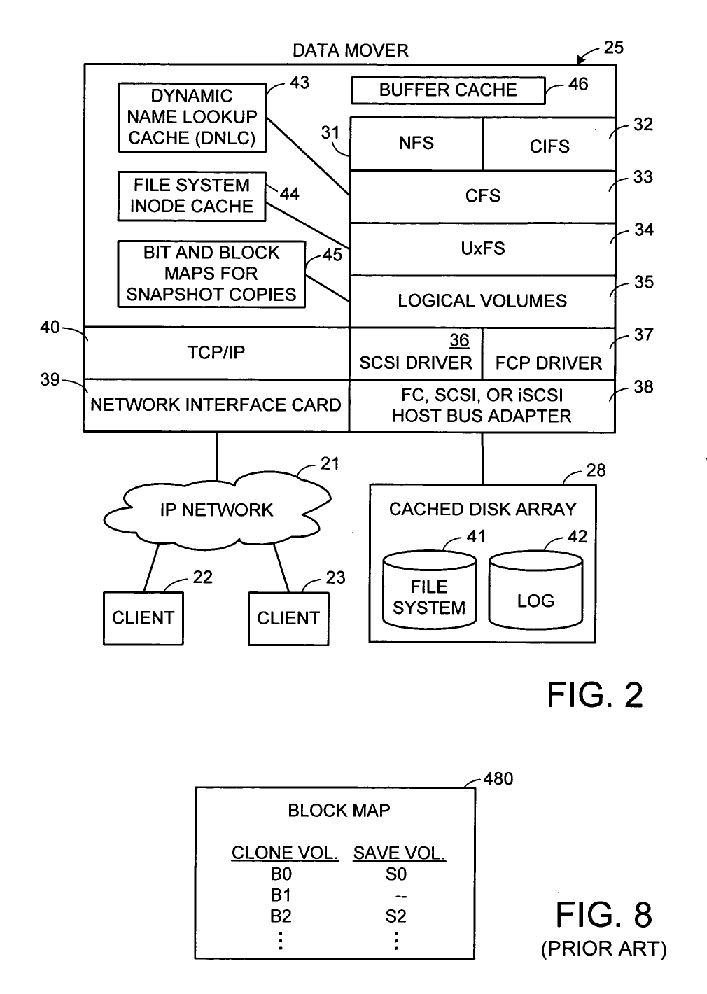

FIG. 2 shows software modules in the data mover 25 introduced in FIG. 1. The data mover 25 has a network file system (NFS) module 31 for supporting communication among the clients and the data movers of FIG. 1 over the IP network 21 using the NFS file access protocol, and a Common Internet File System (CIFS) module 32 for supporting communication over the IP network using the CIFS file access protocol. The NFS module 31 and the CIFS module 32 are layered over a Common File System (CFS) module 33, and the CFS module is layered over a Universal File System (UXFS) module 34. The UxFS module supports a UNIX-based file system, and the CFS module 33 provides higher-level functions common to NFS and CIFS. The UxFS module 34 maintains a file system inode cache 44.

For supporting NFS access, the CFS module 33 maintains a global cache 43 of directory pathname components, which is called the dynamic name lookup cache (DNLC). The DNLC does file system pathname to file handle translation. Each DNLC entry contains a directory or file name and a reference to the inode cache. If there is a cache miss upon lookup in the DNLC, then directory entries must be read from the file system inode cache 44 or the file system 41 on disk and scanned to find the named directory or file. If the DNLC is too small, then lots of processing time will be used up searching the inodes for the named directory or file.

The UxFS module 34 accesses data organized into logical volumes defined by a module 35. Each logical volume maps to contiguous logical storage addresses in the cached disk array 28. The module 35 maintains bit and block maps for snapshot copies, as further described below with reference to FIGS. 8 to 11. The module 35 is layered over an SCSI driver 36 and a Fibre-channel protocol (FCP) driver 37. The data mover 25 sends storage access requests through a host bus adapter 38 using the SCSI protocol, the iSCSI protocol, or the Fibre-Channel protocol, depending on the physical link between the data mover 25 and the cached disk array 28. To enable recovery of the file system 41 to a consistent state after a system crash, the UxFS layer 34 writes file metadata to a log 42 in the cached disk array 28 during the commit of certain write operations to the file system 41.

A network interface card 39 in the data mover 25 receives IP data packets from the IP network. A TCP/IP module 40 decodes data from the IP data packets for the TCP connection and stores the data in buffer cache 46. For example, the UxFS layer 34 writes data from the buffer cache 46 to the file system 41 in the cached disk array 28. The UxFS layer 34 also reads data from the file system 41 or a file system cache 44 and copies the data into the buffer cache 46 for transmission to the network clients 22, 23.

High performance microprocessors for the data movers 25, 26, 27 presently have virtual addresses limited to 32 bits, for a four gigabyte address space. Yet the cost of random access memory has decreased to the point where it is desirable to use more than four gigabytes of physical memory in order to increase data mover performance. For example, file access speed can be increased by increasing the size of the DNLC in order to increase the DNLC hit rate, and processing time for making and accessing snapshot copies can be decreased by increasing the random access memory allocated to the bit and block maps in order to reduce delays for demand paging of the bit and block maps between random access memory and disk storage.

One technique for permitting a 32-bit virtual address to access more than four gigabytes of physical memory is the physical address extension (PAE) feature introduced in the Intel Pentium Pro processor and included in other Intel P6 processors. For example, FIG. 3 shows a block diagram of a microprocessor chip 51 in connection with a random access memory 52. The microprocessor chip 51 includes an interrupt timer, one or more processors 54, a translation buffer 55, a physical address bus 56, an on-chip data cache 57, a data bus 58, an address buffer 59, and a data buffer 60. The microprocessor chip 51 may have multiple physical or logical processors 54. For example, the Intel Xeon processor has two logical processors 54, each of which has a separate set of processor registers.

The interrupt timer 53 periodically interrupts each processor 54 in order to interrupt of a current code thread in order to begin execution of a real-time scheduler code thread. For example, the timer interrupt occurs every 20 milliseconds. Each processor has an interrupt mask 61 in which a bit can be set to enable or cleared to disable the interruption by the interrupt timer.

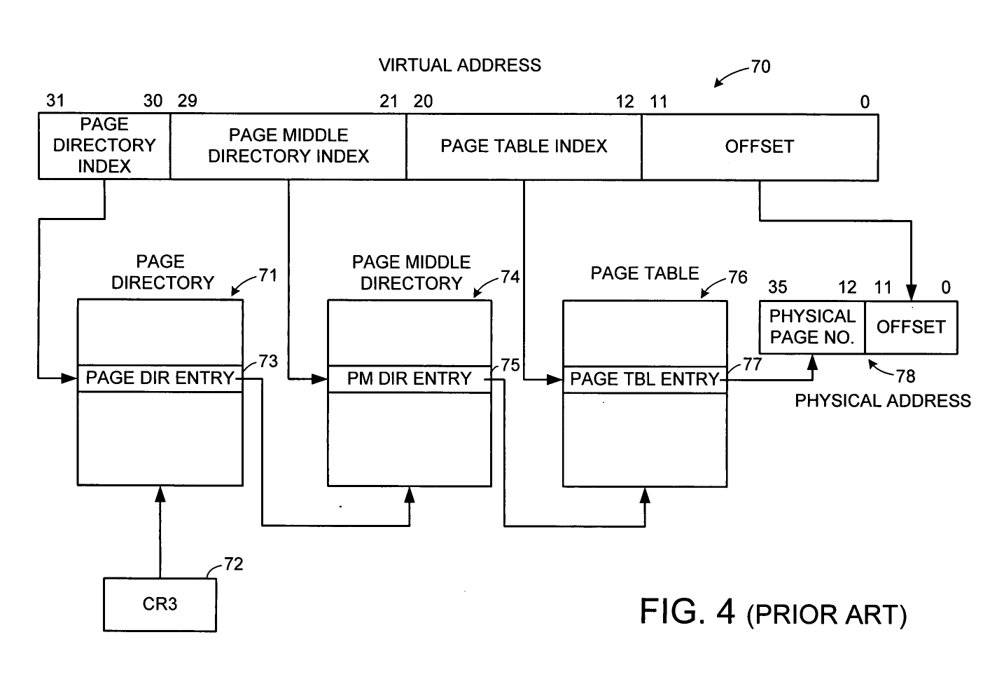

Each processor 54 produces linear addresses. If a paging feature is turned on, the linear addresses are treated as virtual addresses, which are translated into physical addresses for addressing the random access memory 52. A translation buffer 55 attempts to find a physical address translation for each virtual address. If the translation buffer does not contain a physical address translation for a given virtual address, then the processor performs a physical address translation by accessing a series of translation tables as shown and described further below with reference to FIG. 4. The processor then puts the physical address translation into the translation buffer 55 and the translation buffer 55 asserts the physical address onto the address bus 56.

If the addressed data are found in the on-cache data cache 57, then the on-chip data cache 57 asserts the data onto the data bus 58 and the data is supplied from the data bus 58 to the processor 54. Otherwise, if the addressed data are not in the on-chip data cache 57, then an address buffer 59 supplies the physical address from the address bus 56 to the random access memory 52, and a data buffer 60 receives the data from the random access memory 52 and transmits the data over the data bus 58 to the processor 54.

FIG. 4 shows the translation of a 32 bit virtual address 70 into a 36 bit physical address in an Intel microprocessor using Intel's physical address extension (PAE). The translation process involves accessing a series of translation tables including a page directory 71 having four entries, a page middle directory 74 having 512 entries, and a page table 76 having 512 entries. The virtual address 70 is subdivided into a two-bit page directory index (bits 30 to 31 of the virtual address), a nine-bit page middle directory index (bits 21 to 29 of the virtual address), a nine-bit page table index (bits 12 to 20 of the virtual address), and a 12-bit offset (bits 0 to 11 of the virtual address).

A processor control register 72 designated “CR3” provides a base address for addressing a page directory. In a data mover having multiple processors, each processor has a processor “CR3” to that at any given time, each processor may be using a different virtual address space. The indexed entry of the page directory provides a 24-bit base address for addressing a page middle directory. The indexed entry of the page middle directory provides a 24-bit base address for addressing a page table. The indexed entry of the page table provides a physical page number appearing as bits 12 to 35 of the translated physical address 78. The offset in the virtual address appears as bits 0 to 11 of the physical address. Therefore, a virtual-to-physical address translation requires three successive table lookups, unless the translation can be found in the translation buffer.

It has been found that the three levels of indirection in the address translation of a physical address extension (PAE) feature of a processor may cause a loss of performance unless there is an appropriate assignment of virtual memory spaces to well-defined or well-contained software modules executed by the processor. Otherwise, there will be a relatively high frequency of translation buffer misses. In addition, mapping chunks of both common and separate physical address to each of the virtual memory spaces enhances performance by providing efficient communication of parameters to and results from the well-defined or well-contained software modules. For example, a well-defined and well-contained software module performs tasks that have been defined so that memory access during execution of the software module is contained within an assigned one of the available virtual address spaces provided by the PAE feature.

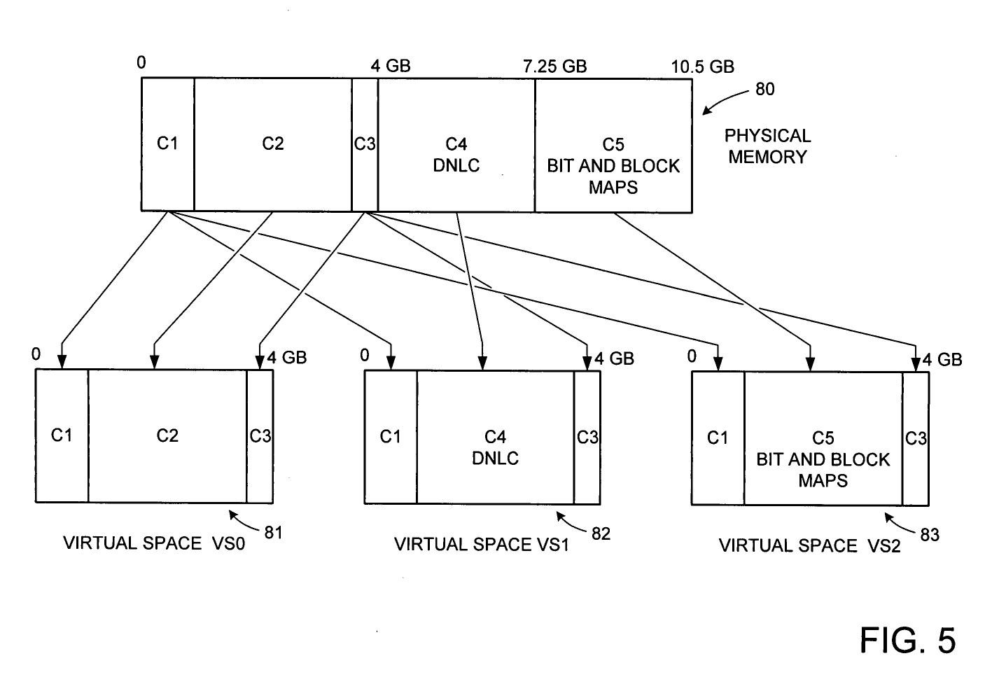

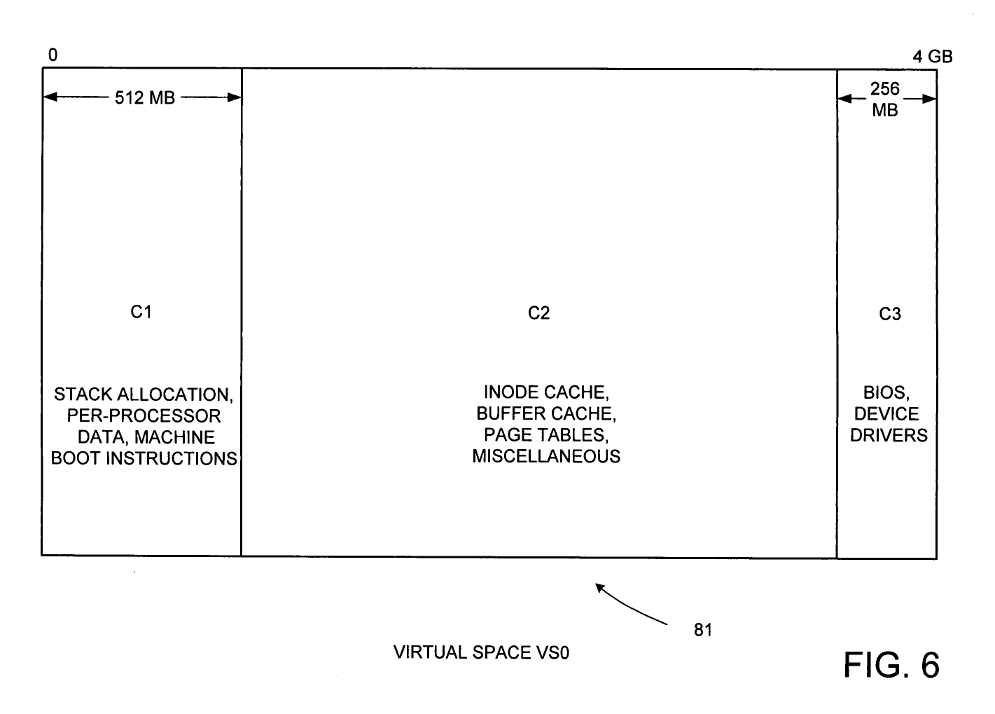

FIGS. 5 and 6, for example, shows a preferred allocation of physical memory chunks to three virtual address spaces for the data mover software introduced in FIG. 2. The physical memory 80 includes a first chunk C1 starting at physical address zero and containing 512 megabytes. This bottom chunk C1 is used for processor stack allocation, per-processor data, and machine boot instructions. The next higher chunk is a second chunk C2 used for the file system inode cache (44 in FIG. 2), the buffer cache (46 in FIG. 2), page tables, and miscellaneous data mover functions. This chunk contains 3.25 gigabytes of physical memory. Unlike a server using a Microsoft operating system, the data movers need not distinguish between user memory space and kernel or operating system memory space. The next higher chunk is chunk C3 containing 256 megabytes at the top of the first four gigabytes of the physical memory 80. The chunk C3 contains BIOS and device drivers. The next higher chunk is chunk C4, which contains the memory for the DNLC (43 in FIG. 2). This chunk C4 contains 3.25 gigabytes of physical memory. The highest chunk is C5, which contains the memory for the bit and block maps for snapshot copies. This highest chunk C5 also contains 3.25 gigabytes of physical memory.

As shown in FIG. 5, the PAE feature maps the physical memory 80 to a first virtual memory space VS0 81, a second virtual memory space VS1 82, and a third virtual memory space VS2 83. Each of these three virtual memory spaces contains four gigabytes of memory. The lower 512 megabytes of each of these three virtual memory spaces is mapped to the same chunk C1. The upper 256 megabytes of each of these three virtual memory spaces is mapped to the same chunk C3. The middle 3.25 gigabytes of the first virtual memory space 81 is mapped to the chunk C2. The middle 3.25 gigabytes of the second virtual memory space 82 is mapped to the chunk C4 for the DNLC. All of the DNLC objects such as the hash and DNLC cache entries are created in the chunk C4. The middle 3.25 gigabytes of the third virtual memory space 83 is mapped to the chunk C5 for the bit and block maps for snapshot copies.

By offloading the memory for the DNLC and the bit and block maps from C2, more memory becomes available to the buffer cache, and the DNLC hash setting can be more aggressive in order to improve performance.

The mapping as shown in FIG. 5 is obtained by disabling paging (so that the physical address is the same as the virtual address) when accessing the first virtual address space, and by programming a number of page directories, page middle directories, and page tables for accessing the second and third virtual address spaces when paging is enabled. For example, there are two page directories, one for each of the second and third virtual address spaces. The first virtual address space is directly mapped to the bottom portion of the physical memory, and the virtual-to-physical address translation can be switched between the other virtual spaces by switching the page directory base address in CR3. There are eight page middle directories, four for each of the second and third virtual address spaces. There could be 4,096 page tables, 2048 for each of the second and third virtual address spaces. The page numbers simply could be listed in a linear fashion in the page table entries, with jumps occurring from virtual address 512M-1 to 512M and from virtual addresses 4G-256M-1 to 4G-256M. In this case there would be page tables identical in content for translating the virtual addresses to most of the physical addresses in the chunks C1 and C2 so these page tables could be shared for translation among the second and third virtual spaces for a reduction in the required number of page tables.

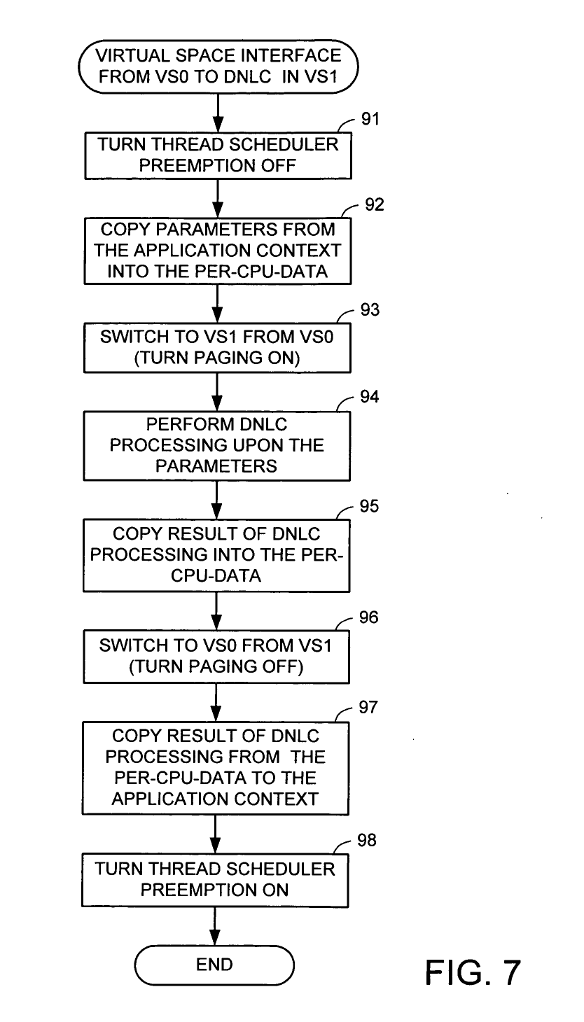

FIG. 7 shows a method of operating the data mover of FIG. 2 for switching between the first virtual address space and the second virtual address space in order to access the domain name lookup cache (DNLC). In a first step 91, thread scheduler preemption is turned off. Once thread scheduler preemption is turned off, if a timer interrupt should happen to occur, the thread scheduler will not suspend execution of the routine of FIG. 7 in order to execute another application thread until the thread scheduler preemption is turned on in step 98. For example, in a data mover, the thread scheduler will not preempt an application thread if the application thread holds one or more spinlocks. A count is kept for each processor of the number of spinlocks held by the application thread currently being executed by the processor. The count is incremented when the current thread begins to acquire a spinlock, and the count is decremented with the current thread releases a spinlock. The thread scheduler compares this count to zero in order to deny preemption if the count is greater than zero. Preemption is turned off by incrementing this count, and preemption is turned back on by decrementing this count.

In step 92, parameters are copied from an application context (running in chunk C2 in the first virtual address space VSO) to the per-processor data region in chunk C1.

In step 93, the virtual-to-physical address translation is switched to VS1 from VS0. For example, when executing applications in VS0, demand paging is turned off, so that the physical address is the same as the virtual address. To switch to VS1, the control register CR3 can be tested to see if it contains the base address of the page directory for VS1, and if so, demand paging is simply turned on. If the control register CR3 does not contain the base address of the page directory for VS1, then CR3 is loaded with the base address of the page directory for VS1 and the translation buffer is flushed of the virtual addresses from 512M to 4G-256M, and demand paging is turned on.

In step 94, the microprocessor performs DNLC processing, for example, to find the inode number of a file having a given path name by successive lookups in the DNLC cache. In step 95, the result of the DNLC processing (such as the desired inode number) is copied into the per-processor data region of chunk C1. Because the parameters and results are exchanged through the per-processor data region, there can be as many concurrent accesses to the DNLC as there are processors in the data mover. In step 96, the microprocessor switches back to VS0 from VS1 by turning off demand paging. In step 97, the microprocessor copies the result of the DNLC processing from the per-processor data region to the application context. Finally, in step 98, the thread scheduler preemption is turned on.

In some situations, it may be desirable to switch between two higher virtual address spaces such as VS1 and VS2. This could be done by setting the control register CR3 to the base address of the page directory for VS2, and flushing the translation buffer of virtual addresses from 512M to 4G-256M-1.

It would be possible to offload a well-defined or well-contained software module from C2 to more than one virtual address space. For example, an additional four-gigabyte virtual space VS3 could be allocated to the bit and block maps for snapshot copies. Additional well-defined or well-contained software modules could be offloaded from VS0 to additional virtual spaces. For example, the UxFS hashing and inode cache could be offloaded to an additional four-gigabyte virtual space VS4.

FIGS. 8 to 11 show the well-defined and self-contained nature of snapshot copy software. The snapshot copy software retains and identifies changes made to a logical volume of data storage. For example, the present state of a file system is stored in a “clone volume,” and old versions of the logical blocks that have been changed in the clone volume are saved in a “save volume”. In order to conserve storage, the logical blocks of the save volume are dynamically allocated to the old versions of the changed blocks as the changes are made to the clone volume.

As shown in FIG. 8, for each logical block that has been changed in the clone volume, a block map 480 identifies the logical block address (Sᵢ) of the old version of the block in the save volume and the corresponding logical block address (Bᵢ) of the changed block in the clone volume.

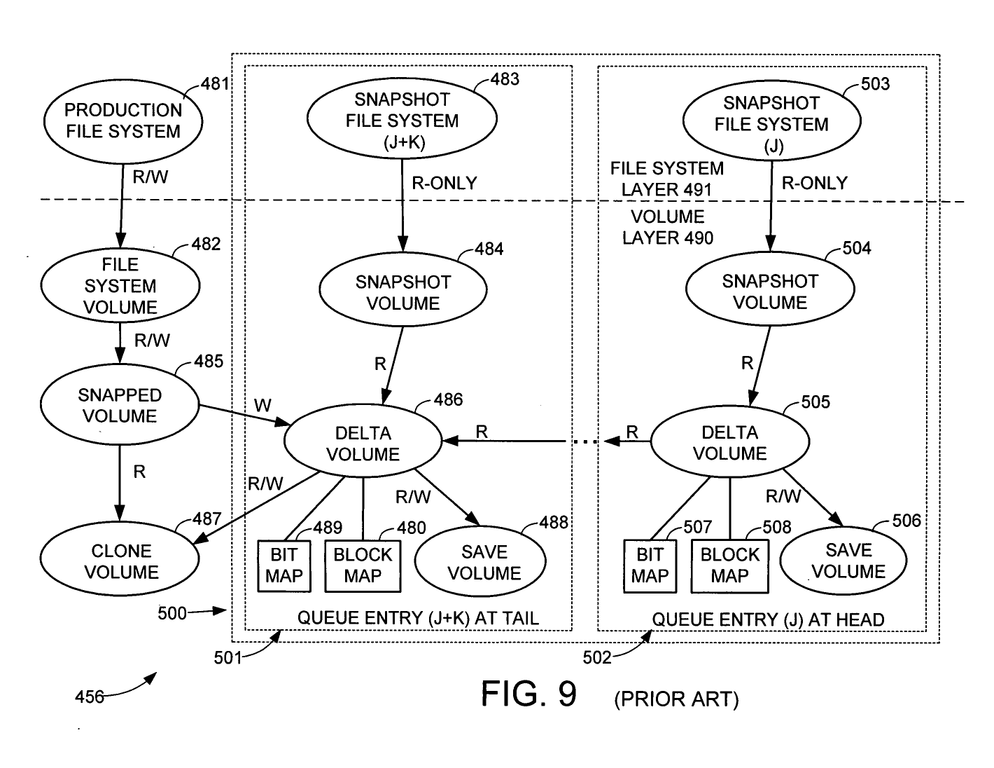

FIG. 9 shows details of the snapshot copy software 456, which provides multiple snapshots 483, 503 of a production file system 481. The content of each snapshot file system 483, 503 is the state of the production file system 481 at a particular point in time when the snapshot was created. The snapshot copy software 456 provides a hierarchy of objects in a volume layer 490 supporting the file systems in a file system layer 491. The production file system 481 is supported by read/write access to a file system volume 482. Each snapshot file system 483, 503 provides read-only access to a respective snapshot volume 484, 504.

Additional objects in the volume layer 490 of FIG. 9 permit the content of each snapshot file system to be maintained during concurrent read/write access to the production file system 481. The file system volume 482 is supported by a snapped volume 485 having read access to a clone volume 487 and write access to a delta volume 486. The delta volume 486 has read/write access to the clone volume 487 and read/write access to a save volume 488.

In the organization of FIG. 9, the actual data is stored in blocks in the clone volume 487 and a respective save volume 488, 506 in storage for each snapshot. The delta volume 486 also accesses information stored in a bit map 489 and the block map 480. The bit map 489 indicates which blocks in the clone volume 487 have prior versions in the save volume 488. In other words, for read-only access to the snapshot file system, the bit map 489 indicates whether the delta volume should read each block from the clone volume 487 or from the save volume 488. For example, the bit map is stored in memory and it includes a bit for each block in the clone volume 487. The bit is clear to indicate that there is no prior version of the block in the save volume 488, and the bit is set to indicate that there is a prior version of the block in the save volume 488.

Consider, for example, a production file system 481 having blocks a, b, c, d, e, f, g, and h. Suppose that when the snapshot file system 483 is created, the blocks have values a0, b0, c0, d0, e0, f0, g0, and h0. Thereafter, read/write access to the production file system 481 modifies the contents of blocks a and b, by writing new values a1 and b1 into them. At this point, the following contents are seen in the clone volume 487 and in the save volume 488:
Clone Volume: a1, b1, c0, d0, e0, f0, g0, h0
Save Volume: a0, b0

From the contents of the clone volume 487 and the save volume 488, it is possible to construct the contents of the snapshot file system 483. When reading a block from the snapshot file system 483, the block is read from the save volume 488 if found there, else it is read from the clone volume 487.

FIG. 9 further shows that a snapshot queue 500 maintains respective objects supporting multiple snapshot file systems 483, 503 created at different respective points in time from the production file system 481. In particular, the snapshot queue 500 includes a queue entry (J+K) at the tail 501 of the queue, and a queue entry (J) at the head 502 of the queue. In this example, the snapshot file system 483, the snapshot volume 484, the delta volume 486, the save volume 488, the bit map 489, and the block map 480 are all located in the queue entry at the tail 501 of the queue. The queue entry at the head of the queue 502 includes similar objects; namely, the snapshot file system (J) 503, a snapshot volume 504, a delta volume 505, a save volume 506, a bit map 507, and a block map 508.

The snapshot copy software 456 may respond to a request for another snapshot of the production file system 481 by allocating the objects for a new queue entry, and inserting the new queue entry at the tail of the queue, and linking it to the snapped volume 485 and the clone volume 487. In this fashion, the save volumes 488, 506 in the snapshot queue 500 are maintained in a chronological order of the respective points in time when the snapshot file systems were created. The save volume 506 supporting the oldest snapshot file system 503 resides at the head 502 of the queue, and the save volume 488 supporting the youngest snapshot file system 483 resides at the tail 501 of the queue.

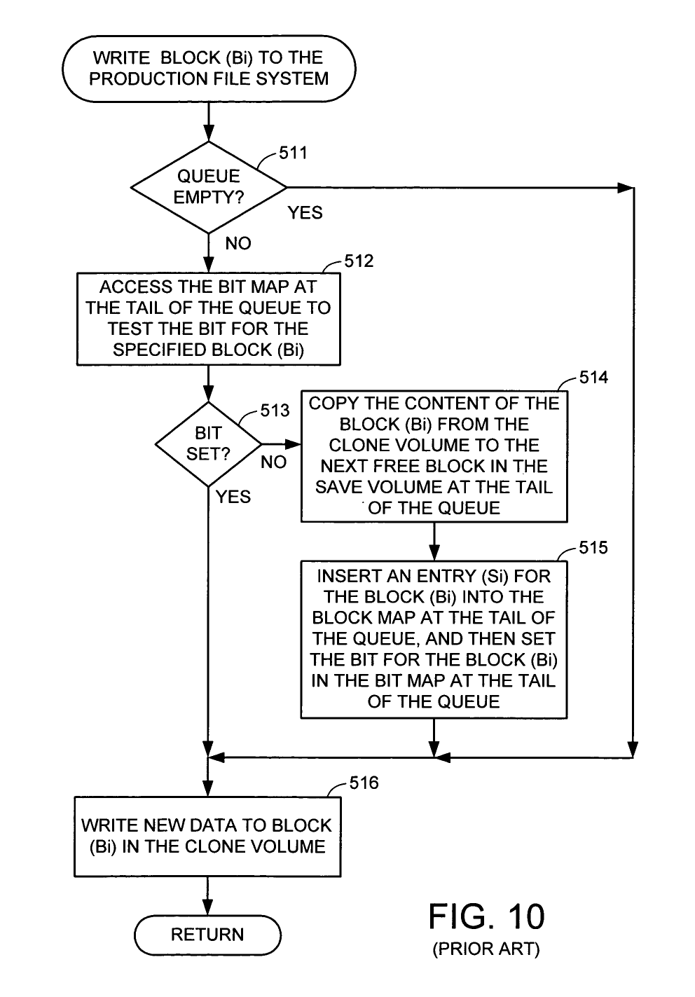

FIG. 10 shows a routine in the snapshot copy software for writing a specified block (Bᵢ) to the production file system. In step 511, if the snapshot queue is not empty, execution continues to step 512. In step 512, the bit map at the tail of the snapshot queue is accessed in order to test the bit for the specified block (Bᵢ). Then in step 513, if the bit is not set, execution branches to step 514. In step 514, the content of the specified block (Bᵢ) is copied from the clone volume to the next free block in the save volume at the tail of the snapshot queue. Execution continues from step 514 to step 515. In step 515, the save volume block address (Sᵢ) of the free block is inserted into the entry for the block (Bᵢ) in the block map at the tail of the queue, and then the bit for the block (Bᵢ) is set in the bit map at the tail of the queue. After step 515, execution continues to step 516. Execution also continues to step 516 from step 513 if the tested bit is found to be set. Moreover, execution continues to step 516 from step 511 if the snapshot queue is empty. In step 516, new data is written to the specified block (Bᵢ) in the clone volume, and then execution returns.

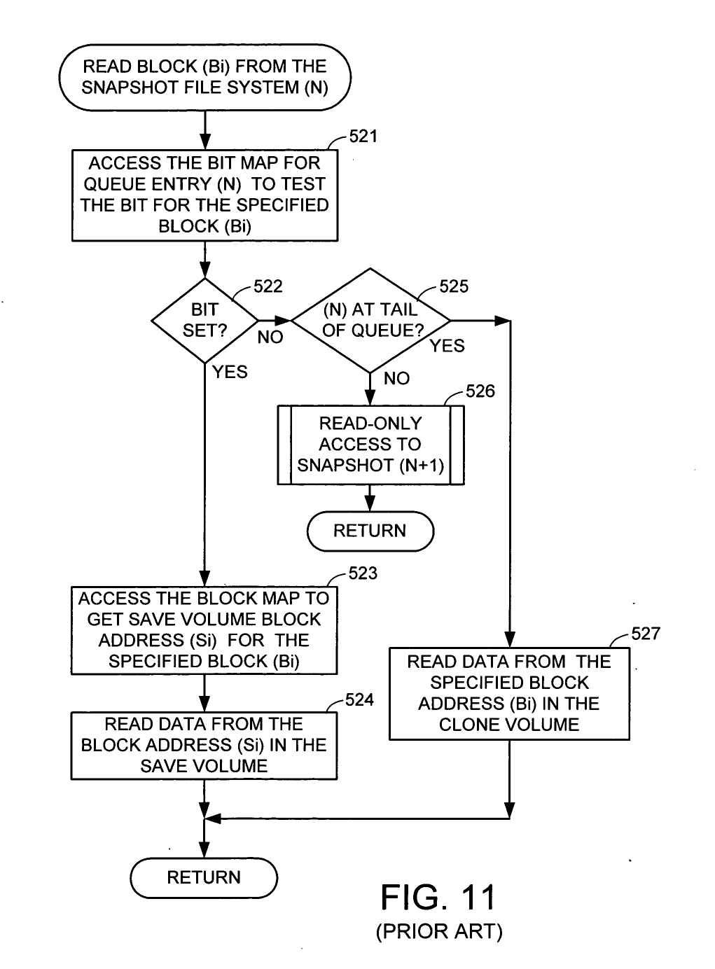

FIG. 11 shows a routine in the snapshot copy software for reading a specified block (Bᵢ) from a specified snapshot file system (N). In the first step 521, the bit map is accessed for the queue entry (N) to test the bit for the specified block (Bᵢ). Then in step 522, if the tested bit is set, execution continues to step 523. In step 523, the block map is accessed to get the save volume block address (Sᵢ) for the specified block (Bᵢ). Then in step 524 the data is read from the block address (Sᵢ) in the save volume, and then execution returns.

If in step 522 the tested bit is not set, then execution branches to step 525. In step 525, if the specified snapshot (N) is not at the tail of the snapshot queue, then execution continues to step 526 to perform a recursive subroutine call upon the subroutine in FIG. 11 for read-only access to the snapshot (N+1). After step 526, execution returns.

If in step 525 the snapshot (N) is at the tail of the snapshot queue, then execution branches to step 527. In step 527, the data is read from the specified block (Bᵢ) in the clone volume, and execution returns.

Additional details regarding the construction and operation of a snapshot copy facility are found in Philippe Armangau U.S. patent application Publication No. US 2004/0030951 A1 published Feb. 12, 2004; Armangau et al. U.S. patent application Publication No. US 2004/0030846 A1 published Feb. 12, 2004; and Armangau et al. U.S. patent application Publication No. US 2004/0030727 A1 published Feb. 12, 2004, all of which are incorporated herein by reference.

In view of the above, there has been described a method of assignment of virtual memory spaces to well defined or well-contained software modules executed by a processor having a physical address extension feature that maps multiple virtual memory spaces to a physical memory containing more memory than can be addressed in a single virtual memory space. Performance is enhanced by mapping chunks of both common and separate physical memory to each of the virtual memory spaces in order to provide efficient communication of parameters to and results from well-defined or well-contained software modules assigned to the separate chunks of physical memory. For example, the common physical memory stores stack allocation, per-processor data for communication between the virtual address spaces, machine boot instructions, BIOS, and device drivers. A first virtual memory space is directly mapped to a bottom region of physical memory containing buffer cache and page tables. In a file server, for example, one of the virtual memory spaces contains an inode cache, another one of the virtual memory spaces contains a domain name lookup cache, and still another one of the virtual memory spaces contains a block map for snapshot copies.

1. A digital computer including at least one processor producing virtual addresses over a range of virtual addresses, a translation buffer coupled to said at least one processor for translating the virtual addresses to physical addresses, and a random access memory coupled to the translation buffer for addressing by the physical addresses and coupled to said at least one processor for supplying data to said at least one processor, wherein the random access memory contains physical memory having a range of physical addresses that is greater than the range of virtual addresses, wherein the digital computer is programmed with a plurality of virtual-to-physical address mappings to define a plurality of virtual memory spaces, each of the plurality of virtual memory spaces includes common physical memory that is included in the other of the virtual memory spaces, and at least one of the virtual memory spaces includes a chunk of physical memory that is not included in any other of the plurality of virtual memory spaces, the chunk of physical memory that is not included in any other of the plurality of virtual memory spaces being assigned for use by a software module, and the digital computer being programmed for using the common physical memory for communication of parameters to and results from the software module.

2. The digital computer as claimed in claim 1, wherein the common physical memory includes physical memory allocated to a stack for said at least one processor.

3. The digital computer as claimed in claim 1, wherein each of the virtual memory spaces includes a chunk of physical memory allocated to BIOS and device drivers, the chunk of physical memory allocated to BIOS and device drivers being common to the plurality of virtual memory spaces.

4. The digital computer as claimed in claim 1, wherein at least one other of the virtual memory spaces is directly mapped to a bottom region of the physical memory address space and is allocated to page tables.

5. The digital computer as claimed in claim 1, wherein the digital computer is programmed for copying at least one parameter from a context of an application to the common physical memory, switching virtual address translation from a virtual memory space of the application to said at least one of the virtual memory spaces, executing the software module for processing said at least one parameter to produce a result placed in the common physical memory, switching the virtual address translation back to the virtual memory space of the application, and copying the result from the common physical memory to the context of the application.

6. The digital computer as claimed in claim 5, wherein the virtual memory space of the application is directly mapped to a bottom region of the physical memory address space, the digital computer is programmed for switching virtual address translation from the virtual memory space of the application to said at least one of the virtual memory spaces by turning paging on, and the digital computer is programmed for switching virtual address translation from said at least one of the virtual memory spaces to the virtual memory space of the application by turning paging off.

7. The digital computer as claimed in claim 1, wherein the digital computer is programmed for switching virtual address translation from the virtual memory space of an application to said at least one of the virtual memory spaces and executing the software module by disabling thread scheduler preemption of the current thread, copying at least one parameter from a context of the application to the common physical memory, switching virtual address translation from the virtual memory space of the application to said at least one of the virtual memory spaces, executing the software module for processing said at least one parameter to produce a result placed in the common physical memory, switching the virtual address translation back to the virtual memory space of the application, copying the result from the common physical memory to the context of the application, and enabling thread scheduler preemption of the current thread.

8. The digital computer as claimed in claim 1, wherein the digital computer is programmed for moving data between network clients and data storage, and the plurality of virtual address spaces include at least a first virtual address space containing an inode cache, a second virtual address space containing a dynamic name lookup cache for finding an inode having a given path name, and a third virtual address space containing a block map for snapshot copies.

9. A digital computer including at least one processor producing virtual addresses over a range of virtual addresses, a translation buffer coupled to said at least one processor for translating the virtual addresses to physical addresses, and a random access memory coupled to the translation buffer for addressing by the physical addresses and coupled to said at least one processor for supplying data to said at least one processor, wherein the random access memory contains physical memory having a range of physical addresses that is greater than the range of virtual addresses, wherein the digital computer is programmed with a plurality of virtual-to-physical address mappings to define a plurality of virtual memory spaces, each of the plurality of virtual memory spaces includes common physical memory that is included in the other of the virtual memory spaces, and each of the plurality of virtual memory spaces including at least one respective separate chunk of physical memory that is not included in any other of the virtual memory spaces, each of the respective separate chunks of physical memory being assigned for use by a respective software module, the digital computer being programmed for using the common physical memory for communication of parameters to and results from the software module, and the plurality of virtual memory spaces including at least a first virtual memory space that is directly mapped to a bottom region of the physical memory address space, a second virtual memory space, and a third virtual memory space.

10. The digital computer as claimed in claim 9, wherein the common physical memory is at the bottom of the physical address space and includes memory allocated to at least one processor stack, and the respective software module assigned to the separate chunk of physical memory in the first virtual address space accesses buffer cache.

11. The digital computer as claimed in claim 9, wherein each of the virtual memory spaces includes a chunk of physical memory allocated to BIOS and device drivers, and the chunk of physical memory allocated to BIOS and device drivers is included in each of the plurality of virtual memory spaces and is mapped to a top region of each of the plurality of virtual memory spaces.

12. The digital computer as claimed in claim 9, wherein the digital computer is programmed for moving data between network clients and data storage, and the respective software modules include software for accessing a dynamic name lookup cache in the separate chunk of physical memory in the second virtual address space, and snapshot copy software for accessing at least one block map in the separate chunk of physical memory in the third virtual address space.

13. A digital computer including at least one processor producing virtual addresses over a range of virtual addresses, a translation buffer coupled to said at least one processor for translating the virtual addresses to physical addresses, and a random access memory coupled to the translation buffer for addressing by the physical addresses and coupled to said at least one processor for supplying data to said at least one processor, wherein the random access memory contains physical memory having a range of physical addresses that is greater than the range of virtual addresses, wherein the digital computer is programmed with a plurality of virtual-to-physical address mappings to define a plurality of virtual memory spaces, each of the plurality of virtual memory spaces includes at least one common chunk of physical memory that is included in the other of the virtual memory spaces, each of the plurality of virtual memory spaces includes at least one respective separate chunk of physical memory that is not included in any other of the virtual memory spaces, each of the respective separate chunks of physical memory is assigned for use by a respective software module, the digital computer is programmed for using the common chunk of physical memory for communication of parameters to and results from the software module, and the plurality of virtual memory spaces includes at least a first virtual memory space that is directly mapped to a bottom region of the physical memory address space, a second virtual memory space, and a third virtual memory space;
wherein the common chunk of physical memory is at the bottom of the physical address space and includes memory allocated to at least one processor stack, and the respective software module assigned to the separate chunk of physical memory in the first virtual address space includes accesses a buffer cache; and
wherein each of the virtual memory spaces includes a chunk of physical memory allocated to BIOS and device drivers, and the chunk of physical memory allocated to BIOS and device drivers is included in each of the plurality of virtual memory spaces and is mapped to a top region of each of the plurality of virtual memory spaces.

14. The digital computer as claimed in claim 13, wherein the digital computer is programmed for moving data between network clients and data storage, and the respective software modules include software for accessing a dynamic name lookup cache in the separate chunk of physical memory in the second virtual address space, and snapshot copy software for accessing at least one block map in the separate chunk of physical memory in the third virtual address space.

15. A method of operating a digital computer for executing a first software module and a second software module, the first software module accessing a first virtual memory space and the second software module accessing a second virtual memory space, each of the first and second virtual memory spaces containing common physical memory, the first virtual memory space including a first separate chunk of physical memory that is not included in the second virtual memory space and that is accessed by the first software module, the second virtual memory space including a second separate chunk of physical memory that is not included in the first virtual memory space and that is accessed by the second software module, wherein the method includes transferring execution between the first software module and the second software module by:
executing the first software module to place at least one parameter in the common physical memory;
switching virtual-to-physical address translation from the first virtual memory space to the second virtual memory space;
executing the second software module to produce a result from said at least one parameter obtained from the common physical memory, the result being placed in the common physical memory,
switching virtual-to-physical address translation from the second virtual memory space to the first virtual memory space; and
executing the first software module to obtain the result from the common physical memory.

16. The method as claimed in claim 15, wherein the switching of the virtual-to-physical address translation from the first virtual memory space to the second virtual memory space is performed by turning paging on, and the switching of the virtual-to-physical address translation from the second virtual memory space to the first virtual memory space is performed by turning paging off.

17. The method as claimed in claim 15, which includes an additional initial step of turning thread scheduler preemption off, and an additional final step of turning the thread scheduler preemption on.

18. The method as claimed in claim 15, which includes addressing more memory space in physical memory than can be addressed by the processor in any one of the first virtual address space and the second virtual address space.

19. The method as claimed in claim 15, which includes the digital computer moving data between network clients and data storage, and execution of the second software module accesses a dynamic name lookup cache in the separate chunk of physical memory contained in the second virtual address space.

20. The method as claimed in claim 19, which includes the digital computer executing snapshot copy software to access a block map in a third virtual address space.
